(19) United States
(12) Patent Application Publication
(10) Pub. No.: US 2009/0144692 A1
(43) Pub. Date: Jun. 4, 2009

(54) METHOD AND APPARATUS FOR MONITORING OPTICAL PROXIMITY CORRECTION PERFORMANCE

(76) Inventors: JASON P. CAIN, Austin, TX (US); Kevin R. Lensing, Austin, TX (US); Bhanwar Singh, Morgan Hill, CA (US); Luigi Capodieci, Santa Cruz, CA (US); Cyrus E. Tabery, San Jose, CA (US)

Correspondence Address: Scott F. Diring;WILLIAMS, MORGAN & AMERSON, P.C., Suite 1100, 10333 Richmond Drive, Houston, TX, 77042, US

(21) Appl. No.: 11/948,151

(22) Filed: Nov. 30, 2007

(51) Int. Cl. G06F 17/50

(52) U.S. Cl. 716/19

(57) ABSTRACT

A method includes specifying a plurality of optical proximity correction metrology sites on a wafer. Metrology data is collected from at least a subset of the metrology sites. Data values are predicted for the subset of the metrology sites using an optical proximity correction design model. The collected metrology data is compared to the predicted data values to generate an optical proximity correction metric. A problem condition associated with the optical proximity correction design model is identified based on the optical proximity correction metric.

### CROSS-REFERENCE TO RELATED APPLICATIONS

Not applicable.

### BACKGROUND OF THE INVENTION

The disclosed subject matter relates generally to integrated circuit manufacturing and, more particularly, to a method and apparatus for monitoring optical proximity correction performance.

The formation of various integrated circuit (IC) structures on a wafer often relies on lithographic processes, sometimes referred to as photolithography, or simply lithography. As is well known, lithographic processes can be used to transfer a pattern of a photomask (also referred to herein as a mask or a reticle) to a wafer.

For instance, patterns can be formed from a photoresist layer disposed on the wafer by passing light energy through a mask having an arrangement to image the desired pattern onto the photoresist layer. As a result, the pattern is transferred to the photoresist layer. In areas where the photoresist is sufficiently exposed, and after a development cycle, the photoresist material becomes soluble such that it can be removed to selectively expose an underlying layer (e.g., a semiconductor layer, a metal or metal containing layer, a dielectric layer, a hard mask layer, etc.). Portions of the photoresist layer not exposed to a threshold amount of light energy will not be removed and serve to protect the underlying layer during further processing of the wafer (e.g., etching exposed portions of the underlying layer, implanting ions into the wafer, etc.). Thereafter, the remaining portions of the photoresist layer can be removed.

There is a pervasive trend in the art of IC fabrication to increase the density with which various structures are arranged. For example, feature size, line width, and the separation between features and lines are becoming increasingly smaller. In these sub-micron processes, yield is affected by factors such as mask pattern fidelity, optical proximity effects and photoresist processing. Some of the more prevalent concerns include line end pullback, corner rounding and line-width variations. These concerns are largely dependent on local pattern density and topology.

Optical proximity correction (OPC) has been used to improve image fidelity. In general, current OPC techniques involve running a computer simulation that takes an initial data set having information relating to the desired pattern and manipulates the data set to arrive at a corrected data set in an attempt to compensate for the above-mentioned concerns. A photomask can then be made in accordance with the corrected data set. Briefly, the OPC process can be governed by a set of geometrical rules (i.e., “rule-based OPC” employing fixed rules for geometric manipulation of the data set), a set of modeling principles (i.e., “model-based OPC” employing predetermined behavior data to drive geometric manipulation of the data set), or a hybrid combination of rule-based OPC and model-based OPC.

The process of generating an OPC model is time intensive and expensive. Techniques for evaluating OPC models involve intensively manual processes that are time consuming and prone to errors and/or omissions. Briefly, verifying OPC models involve hand checking the layout corrections made to a test pattern to verify that the OPC routine applying the OPC model performs in an expected manner. Typically, OPC model building and validation is a one-time event that occurs well before products reach manufacturing. The model is validated based on test patterns when the process transfers to manufacturing, but it is typically not re-examined thereafter.

This section of this document is intended to introduce various aspects of art that may be related to various aspects of the disclosed subject matter described and/or claimed below. This section provides background information to facilitate a better understanding of the various aspects of the disclosed subject matter. It should be understood that the statements in this section of this document are to be read in this light, and not as admissions of prior art. The disclosed subject matter is directed to overcoming, or at least reducing the effects of, one or more of the problems set forth above.

### BRIEF SUMMARY OF THE INVENTION

The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

One aspect of the disclosed subject matter is seen in a method that includes specifying a plurality of optical proximity correction metrology sites on a wafer. Metrology data is collected from at least a subset of the metrology sites. Data values are predicted for the subset of the metrology sites using an optical proximity correction design model. The collected metrology data is compared to the predicted data values to generate an optical proximity correction metric. A problem condition associated with the optical proximity correction design model is identified based on the optical proximity correction metric.

Another aspect of the disclosed subject matter is seen in a method that includes specifying a plurality of optical proximity correction metrology sites on a wafer. Metrology data is collected from at least a subset of the metrology sites. The collected metrology data is compared to predicted data values for the associated metrology sites to generate an optical proximity correction metric. At least one operating recipe parameter is determined for a photolithography tool operable to process the wafers based on the optical proximity correction metric.

### BRIEF DESCRIPTION OF THE SEVERAL VIEWS OF THE DRAWINGS

The disclosed subject matter will hereafter be described with reference to the accompanying drawings, wherein like reference numerals denote like elements, and:

FIG. 1 is a simplified block diagram of a manufacturing system in accordance with one illustrative embodiment;

FIG. 2 is a simplified diagram of a semiconductor feature; and

FIG. 3 is a simplified flow diagram of a method for monitoring the performance of an optical proximity correction model in accordance with another illustrative embodiment.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the spirit and scope of the disclosed subject matter as defined by the appended claims.

### DETAILED DESCRIPTION OF THE INVENTION

One or more specific embodiments of the disclosed subject matter will be described below. It is specifically intended that the disclosed subject matter not be limited to the embodiments and illustrations contained herein, but include modified forms of those embodiments including portions of the embodiments and combinations of elements of different embodiments as come within the scope of the following claims. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the disclosed subject matter unless explicitly indicated as being “critical” or “essential.”

The disclosed subject matter will now be described with reference to the attached figures. Various structures, systems and devices are schematically depicted in the drawings for purposes of explanation only and so as to not obscure the disclosed subject matter with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

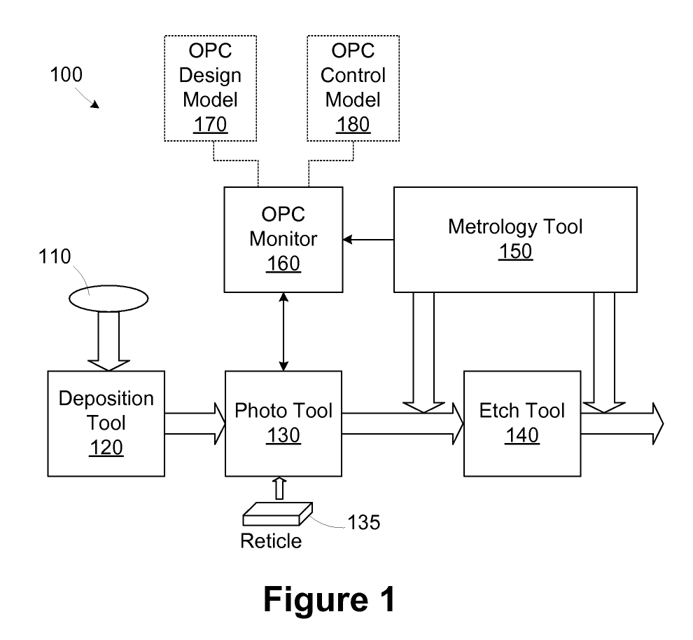

Referring now to the drawings wherein like reference numbers correspond to similar components throughout the several views and, specifically, referring to FIG. 1, the present invention shall be described in the context of an illustrative manufacturing system 100 for processing wafers 110 in accordance with one illustrative embodiment of the present invention is provided. In the illustrated embodiment, the manufacturing system 100 includes a deposition tool 120 for forming one or more process layers on the wafer 110, a photolithography tool 130 for patterning the layers, an etch tool 140 for etching various features in the various process layers, a metrology tool 150 for measuring features on the wafer 110, and an optical proximity correction (OPC) monitor 160. In general, the OPC monitor 160 compares measured feature dimensions to predicted feature dimensions generated using an OPC design model 170. In some embodiments, the OPC monitor 160 may also employ an OPC control model 180 for controlling one or more operating recipe parameters of the photolithography tool 130 based on measured feedback related to OPC characteristics.

In the illustrated embodiment, the OPC monitor 160 is a computer programmed with software to implement the functions described. However, as will be appreciated by those of ordinary skill in the art, a hardware controller designed to implement the particular functions may also be used. Moreover, the functions performed by the OPC monitor 160, as described herein, may be performed by multiple devices distributed throughout a system. Additionally, the OPC monitor 160 may be a stand-alone device, it may be integrated into a tool, such as the photolithography tool 130, or it may be part of a system controlling operations in an integrated circuit manufacturing facility.

Portions of the invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The deposition tool 120 may be used to form process layers for a semiconductor device, such as polysilicon layers, dielectric layers, metal layers, etc. The photolithography tool 130 employs a reticle 135 and a light source (not shown) for exposing layers of photoresist as part of the process of generating a mask for subsequent etching of the process layers. The etch tool 140 may be employed to form features of the semiconductor device from the process layers. For ease of illustration and to avoid obscuring the present invention, only a portion of the manufacturing system 100 is illustrated. An actual implementation of the manufacturing system 100 may have additional types of tools and multiples instances of each tool type. For example, different etch tools and/or deposition tools may be used to form the process layers or features described above. A particular wafer 110 may be processed multiple times in multiple deposition, photolithography, etch, or other tools to fabricate completed devices thereon. The tools 120, 130, 140 may also comprise cluster tools with multiple chambers or components.

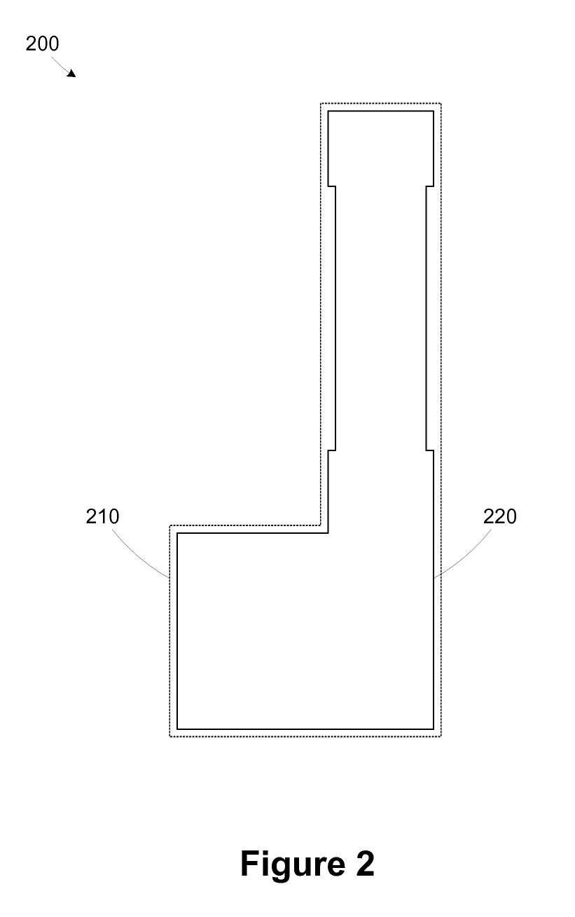

In general, the reticle 135 is created using design information for the devices being fabricated. Using the OPC design model 170 the characteristics of the mask are modified to compensate for optical proximity effects, as described above. FIG. 2 illustrates one example of how the reticle 135 may be modified in accordance with OPC techniques. In FIG. 2, an exemplary feature 200 on the reticle 135 is illustrated. Of course, in an actual embodiment many features a present and multiple layers of features are employed. The simplified feature of FIG. 2 is provided for illustrative purposes. The design dimensions of the reticle feature 200 are shown in phantom as a design feature 210. After processing the design through the OPC design model 170, the characteristics of the design feature 210 are modified to generate an OPC corrected feature 220. The OPC corrected feature 220 represents the pattern actually formed on the reticle 135. If the OPC design model 170 is well matched to the photolithography process performed by the photolithography tool 130, the actual printed feature should relatively closely correspond to the design feature 210.

The OPC monitor 160 receives metrology data from the metrology tool 150 regarding dimensions of the photoresist feature formed by the photolithography tool 130 or features formed on the wafer 110 during production (e.g., such as the device feature corresponding to the reticle feature 200 or other designated features). Various tools may be used as the metrology tool 150 to collect the dimension data, such as a scanning electron microscope (SEM), optical metrology tool, etc. Hence, the metrology tool 150 is intended to represent one or more tools of the same or different type that collect dimensional information regarding the photoresist or production features formed on the wafer 110. Multiple features may be designated throughout the layout as being associated with OPC monitoring. These sites may be measured on a sampling basis during production.

In one embodiment, the OPC monitor 160 operates in a fault detection mode. The OPC monitor 160 compares the measured feature dimension(s) to predicted feature dimension(s). The predicted dimensions may represent design dimensions or corrected dimensions generated by the OPC design model 170. If the magnitude of the difference between the measured feature dimension and the predicted feature dimension exceeds a fault threshold (e.g., static or dynamic threshold), the OPC monitor 160 may indicate an OPC alert or fault condition. To distinguish between OPC and “regular” dimensional variation (e.g., non-OPC or critical dimension process control), the OPC measurements may be normalized relative to the mean of the non-OPC measurements to reduce noise in the OPC monitor 160 related to manufacturing variation as opposed to OPC variation.

The OPC verification may be performed using a small subset of the sites used for generating and/or validating the OPC design model 170. Generally, the sites are selected to be representative of different regions of the OPC model space. These sites need not be specified on the same wafer. For example, subsets of the defined OPC sited may be sampled across multiple production wafers and/or wafer lots. Over time, metrology data may be collected that covers the designated OPC sites. Metrology frequencies may be assigned based on metrology capacity and the consideration of process or metrology noise. If the model predictions compared to the actual feature dimensions result in the determination that the performance of the OPC design model 170 is marginal (e.g., exceeds an alert threshold), the OPC monitor 160 may signal an alert condition to a process engineer or operator.

Subsequently, the sampling set specified for OPC verification may be expanded to cover additional sites (i.e., to increase the breadth of OPC model verification) or to increase the sampling rate of the various sites (i.e., to reduce noise). If the comparison of the feature dimension data to the model predicted dimension data over the expanded sample set still indicates marginal performance, an OPC fault message may be generated.

Following an OPC fault message, production of the associated devices may be suspended until further corrective actions may be completed. For example, the OPC design model 170 may be re-verified using test patterns and subsequent metrology. If the nature of the dimensional variation is such that an increased likelihood of faulty or poor-performing devices is present, the reticle 135 may be replaced with a new reticle generated using an updated OPC design model 170.

In another embodiment, the OPC monitor 160 may also function as a controller that determines one or more operating recipe parameters of the photolithography tool 130 to attempt to reduce variation in the feature dimensions at the OPC sites. To that end, the OPC monitor 160 may employ an OPC control model 180 that relates photolithography parameters, such as dose, focus, illumination type, sigma, numerical aperture, etc., to dimension control. The OPC control model 180 may be developed empirically using commonly known linear or non-linear techniques. The OPC control model 180 may be a relatively simple equation based model (e.g., linear, exponential, weighted average, etc.) or a more complex model, such as a neural network model, principal component analysis (PCA) model, or a projection to latent structures (PLS) model. The specific implementation of the model may vary depending on the modeling technique selected.

By modeling dimensional performance and using the OPC control model 180 to adjust the operating recipe, the OPC monitor 160 may react to minor disturbances in the accuracy of the OPC design model 170 predictions prior to an OPC alert or fault condition being reached. The metrology data collected at the specified OPC metrology sites may be used for fault detection, as described above, as well as for process control. In the process control technique, the OPC monitor 160 receives metrology data for one or more OPC sites and uses the difference between the measured feature dimensions and the feature dimensions generated by the OPC design model 170 to generate an error signal. One or more operating recipe parameters of the photolithography tool 130 may be adjusted based on the error signal to attempt to reduce variation between the actual and predicted feature dimensions.

In the illustrated embodiment, the OPC fault and process control determinations are not performed on each metrology data point individually, but rather on a set of OPC related data collected from various sites. Performing OPC fault detection or process control based on individual site measurements may give rise to difficulties in distinguishing between conventional process control dimension variation and OPC model related issues. Hence, OPC data is evaluated collectively over the model space. Again, the OPC measurements may be normalized relative to the mean of the non-OPC measurements to reduce noise related to manufacturing variation. In one technique, individual weighted averages are maintained for each OPC site. Based on the individual weighted averages, an aggregate metric may be determined. The aggregate metric provides an overall measure of the efficacy of the OPC design model 170 over the specified model space. Different aggregate metrics may be determined for different aspects of the OPC design model 170. For example, different aggregate metrics may be determined for different feature types.

In another technique, a snapshot of the OPC model performance may be taken at predetermined intervals as opposed to continuously. For example, an OPC analysis may be completed once per shift, once per day, etc. Alternatively, the OPC analysis may be completed after a certain percentage of the designated OPC sites are measured. Using a snapshot approach, an aggregate OPC metric may be determined for the current set of measurements. The frequency of the analysis may vary depending on the available metrology capacity and the sensitivity of the OPC variation.

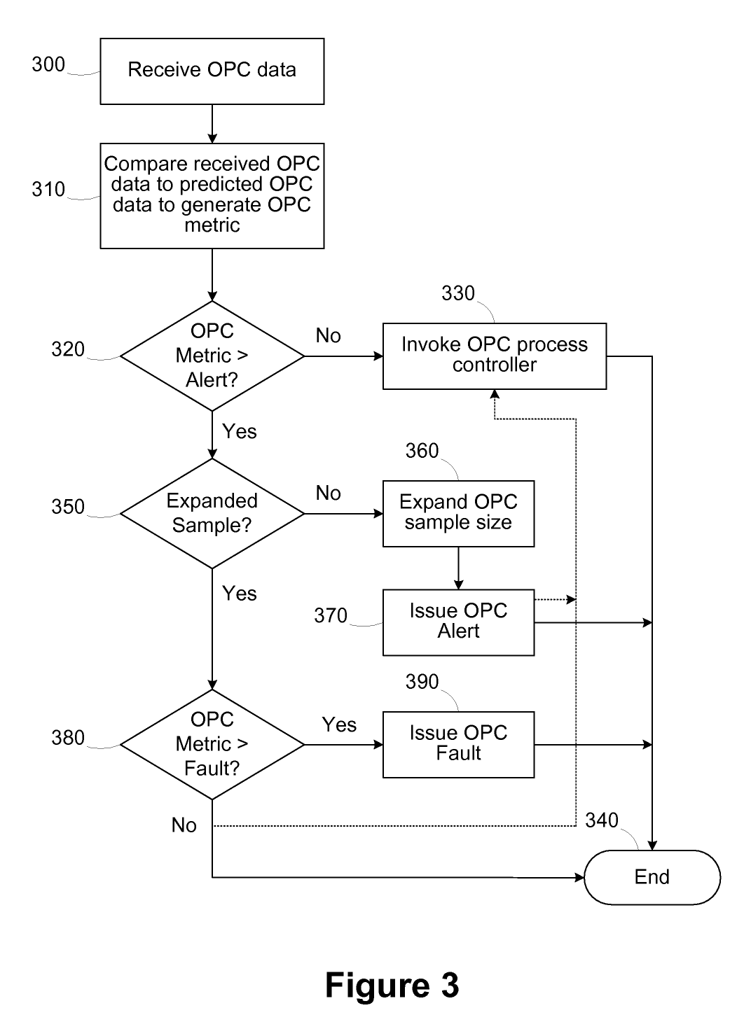

FIG. 3 illustrates a simplified flow diagram for an integrated OPC fault detection and process control technique. In method block 300, OPC metrology data is received. As described above, this may include a single OPC data point that is used to update a weighted average for the site, or it may represent a current snapshot of the OPC sites. In method block 310, the OPC metrology data is compared to predicted values for the OPC data to determine an OPC metric indicating the efficacy of the prediction. If the OPC metric does not exceed an alert threshold in method block 320, the OPC controller functionality of the OPC monitor 160 is invoked to attempt to reduce the OPC variation in method block 330, and the method terminates in method block 340.

If the OPC metric exceeds the alert threshold in method block 320, it is determined if an expanded OPC sample indication is present (i.e., to the presence of a previous Alert) in method block 350. If the expanded OPC sample set was not previously indicated, the sample size is increased in method block 360 and an OPC alert is issued in method block 370. After the issuance of the OPC alert, the method may terminate in method block 340, or alternatively (i.e., as indicated in phantom), the OPC process controller may be invoked in method block 330. An existing OPC alert may be terminated manually by a process engineer or operator or automatically after a previous alert clears in method block 320. After an alert is cleared, the OPC sample size may be reduced to the original set to conserve metrology resources.

If the expanded sample size was already specified in method block 350, the OPC metric is compared to a fault threshold in method block 380. If no fault is present, the method terminates in method block 340 or the OPC process controller is invoked in method block 330. If an OPC fault is determined in method block 380, an OPC fault is issued in method block 390 and the method terminates in method block 340. The OPC controller is not typically invoked after the identification of a fault condition as more intensive investigation and corrective action is generally required.

Monitoring the efficacy of the OPC design model 170 using production metrology data has numerous advantages. Marginal model performance may be identified and corrected earlier in the production flow. If the degradation in model performance were not identified, corrective action may be delayed until significant yield issues were identified at the end of the production flow when completed devices are subjected to functional testing. Smaller deviations in model performance may be corrected for during production using the OPC control model 180, thereby reducing the impact of model performance changes.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the disclosed subject matter. Accordingly, the protection sought herein is as set forth in the claims below.

We claim:

1. A method, comprising:
specifying a plurality of optical proximity correction metrology sites on a wafer;
collecting metrology data from at least a subset of the metrology sites;
predicting data values for the subset of the metrology sites using an optical proximity correction design model;
comparing the collected metrology data to the predicted data values to generate an optical proximity correction metric; and
identifying a problem condition associated with the optical proximity correction design model based on the optical proximity correction metric.

2. The method of claim 1, wherein comparing the collected metrology data to the predicted data values further comprises:
determining a weighted average of the metrology data for at least each of the metrology sites in the subset; and
generating the optical proximity correction metric based on the weighted averages.

3. The method of claim 1, further comprising normalizing the metrology data with respect to a mean value associated with production metrology data collected at sites other than optical proximity correction metrology sites.

4. The method of claim 1, further comprising increasing a size of the subset responsive to identifying the problem condition.

5. The method of claim 4, further comprising:
generating the optical proximity correction metric for the increased size subset; and
identifying a fault condition associated with the optical proximity correction design model based on the optical proximity correction metric.

6. The method of claim 1, wherein the metrology data comprises dimension data.

7. The method of claim 1, further comprising:
defining a plurality of model spaces for the optical proximity correction design model;
assigning each of the metrology sites to one of the model spaces;
generating an optical proximity correction metric for each of the model spaces; and
identifying the problem condition based on the generated optical proximity correction metrics.

8. The method of claim 7, wherein each model space is associated with a particular feature type.

9. The method of claim 1, further comprising determining at least one operating recipe parameter for a photolithography tool operable to process the wafers based on the optical proximity correction metric.

10. The method of claim 9, wherein the operating recipe parameter comprises at least one of a dose parameter, a focus parameter, an illumination type parameter, a sigma parameter, and a numerical aperture parameter.

11. A method, comprising:
specifying a plurality of optical proximity correction metrology sites on a wafer;
collecting metrology data from at least a subset of the metrology sites;
comparing the collected metrology data to predicted data values for the associated metrology sites to generate an optical proximity correction metric; and
determining at least one operating recipe parameter for a photolithography tool operable to process the wafers based on the optical proximity correction metric.

12. The method of claim 11, wherein the operating recipe parameter comprises at least one of a dose parameter, a focus parameter, an illumination type parameter, a sigma parameter, and a numerical aperture parameter.

13. The method of claim 11, further comprising predicting the data values for the subset of the metrology sites using an optical proximity correction design model.

14. The method of claim 13, further comprising determining the at least one operating recipe parameter for the photolithography tool using an optical proximity correction control model.

15. The method of claim 13, further comprising:
defining a plurality of model spaces for the optical proximity correction design model;
assigning each of the metrology sites to one of the model spaces;
generating an optical proximity correction metric for each of the model spaces; and
determining the at least one operating recipe parameter for the photolithography tool on the optical proximity correction metrics.

16. The method of claim 15, wherein each model space is associated with a particular feature type.

17. The method of claim 11, wherein the metrology data comprises dimension data.

18. The method of claim 11, further comprising processing subsequent wafers using the determined at least one operating recipe parameter.

19. A system, comprising:
a metrology tool operable to collect metrology data from at least a subset of optical proximity correction metrology sites specified on a wafer; and
an optical proximity correction monitor operable to predict data values for the subset of the metrology sites using an optical proximity correction design model, compare the collected metrology data to the predicted data values to generate an optical proximity correction metric, and identify a problem condition associated with the optical proximity correction design model based on the optical proximity correction metric.

20. The system of claim 19, wherein the optical proximity correction monitor is operable to increase a size of the subset responsive to identifying the problem condition, generate the optical proximity correction metric for the increased size subset, and identify a fault condition associated with the optical proximity correction design model based on the optical proximity correction metric.

21. A system, comprising:
a photolithography tool operable to pattern wafers for forming features thereon;
a metrology tool operable to collect metrology data from at least a subset of optical proximity correction metrology sites specified on at least one wafer; and
a controller operable to compare the collected metrology data to predicted data values for the associated metrology sites to generate an optical proximity correction metric and determine at least one operating recipe parameter for the photolithography tool based on the optical proximity correction metric.

22. The system of claim 21, wherein the operating recipe parameter comprises at least one of a dose parameter, a focus parameter, an illumination type parameter, a sigma parameter, and a numerical aperture parameter.

23. The system of claim 21, wherein the controller is operable to receive the predicted data values for the subset of the metrology sites as generated by an optical proximity correction design model and determine the at least one operating recipe parameter for the photolithography tool using an optical proximity correction control model.
